(19) United States
(12) Patent Application Publication
(10) Pub. No.: US 2026/0329702 A1
(43) Pub. Date: Oct. 22, 2026

(54) CONTEXTUALLY INTELLIGENT DISASTER RECOVERY SYSTEM

(71) Applicant: Bernt Erik Bjontegard, San Diego, CA (US)

(72) Inventors: Bernt Erik Bjontegard, San Diego, CA (US); Courtney H Cobey, San Diego, CA (US)

(21) Appl. No.: 19/446,921

(22) Filed: Jan. 12, 2026

Related U.S. Application Data
(60) Provisional application No. 63/744,519, filed on Jan. 13, 2025.

(51) Int. Cl. G06F 11/1446

(52) U.S. Cl. CPC G06F 11/1469

(57) ABSTRACT

A disaster recovery system facilitating recovery and rebuilding efforts in affected areas by integrating a computing unit with a plurality of data sources is disclosed. A central controller, connected to the computing unit, processes real-time data on property damage, environmental conditions, and infrastructure integrity. The disaster recovery system includes a data ingestion module that normalizes, aggregates, and stores data, and a contextualization module that extracts metadata and generates insights on the impacted area. A decision engine, equipped with a damage categorization module powered by machine learning, prioritizes damage severity and resource allocation. The disaster recovery system automates permit application generation, ensuring compliance with local regulations. Furthermore, a rapid permit processing module integrates with government agencies to expedite permit issuance. By assessing real-time damage and optimizing resource allocation, the disaster recovery system enhances disaster preparedness, response, and recovery, providing an efficient and coordinated approach to rebuilding efforts.

### FIELD OF THE INVENTION

The present invention relates to the field of disaster recovery, more specifically to a disaster recovery system to collect, process, and analyze real-time data from a plurality of sources to recover and rebuild the process in the areas affected by the disaster.

### BACKGROUND

Natural disasters, including hurricanes, earthquakes, floods, wildfires, and tornadoes, often leave behind a trail of destruction that affects homes, businesses, and critical infrastructure such as roads, bridges, utilities, and communication networks. Beyond the immediate damage, communities face prolonged recovery periods that can last months or even years. In 2024 alone, the U.S. faced catastrophic events such as the Los Angeles wildfires, Florida hurricanes, and Midwest tornadoes, causing damages exceeding $300 billion. These events highlight the urgent need for an innovative and efficient solution to streamline rebuilding efforts.

This extended timeline is attributed to systemic inefficiencies, including delays in processing rebuilding permits, disorganized data collection efforts, and ineffective coordination among key stakeholders. Recovery efforts typically involve government agencies, local authorities, construction firms, insurance companies, humanitarian organizations, and affected residents. However, these entities often work in isolation, relying on disparate systems and workflows that impede their ability to respond swiftly and collaboratively to the challenges of post-disaster recovery.

One major challenge is the overwhelming surge in permit applications following a disaster. Manual permitting processes are unable to manage this influx efficiently, leading to significant delays that hinder rebuilding efforts and prolong economic losses for affected communities. Compounding this issue is the lack of real-time insights during disaster scenarios. Decision-makers often struggle to access actionable data, such as integrated damage assessments and environmental information, which are critical for prioritizing resource allocation and streamlining workflows. This absence of timely and reliable information slows recovery efforts and reduces their effectiveness.

Infrastructure damage further complicates recovery by disrupting communication networks and creating barriers to coordination among key stakeholders such as emergency responders, local governments, and rebuilding teams. Without functioning communication systems, collaboration becomes fragmented, resulting in delays and misaligned recovery efforts. Resource management also suffers from this fragmentation. Without a centralized system to oversee the deployment of funding, construction materials, and labor, resources are often allocated inefficiently, leading to waste, duplication, and slowed progress.

Compliance with updated building codes and safety regulations presents an additional challenge. Adhering to these standards is critical for ensuring resilience against future disasters, but manual processes make this compliance time-consuming and error-prone. These inefficiencies slow permit issuance and increase the risk of substandard construction, further jeopardizing the recovery process. Moreover, the absence of centralized reporting mechanisms leaves residents and stakeholders uninformed about recovery progress, reducing transparency and eroding public trust.

One of the primary obstacles is the absence of real-time data collection and analysis capabilities. Current systems rely heavily on manual processes or outdated technologies that are unable to capture the dynamic and rapidly evolving conditions in disaster-hit areas. Without accurate and up-to-date data, decision-making becomes fragmented, leading to critical delays in identifying priorities, allocating resources, and initiating reconstruction. For instance, rebuilding permits often require extensive documentation, including damage assessments and compliance checks, which are frequently delayed due to incomplete or inconsistent data. This not only slows down the rebuilding process but also places an additional burden on disaster-stricken communities already grappling with significant losses.

Additionally, resource allocation during recovery efforts is often inefficient due to the lack of a centralized and transparent platform that can provide situational awareness to all stakeholders. This creates a cascading effect where aid, materials, and manpower may be misdirected, delayed, or duplicated, further compounding the recovery challenges. The absence of effective communication and data-sharing mechanisms among agencies and organizations prevents the establishment of a unified response strategy, leaving gaps in coordination that hinder timely and efficient disaster recovery operations.

Given the scale and complexity of these challenges, there is a critical need for an integrated, intelligent system capable of addressing the inherent inefficiencies in post-disaster recovery. Such a system should utilize advanced technologies to enable real-time data collection, automated analysis, and dynamic decision-making while providing seamless collaboration among all parties involved.

### SUMMARY

The present invention relates to the field of disaster recovery, more specifically to a disaster recovery system to collect, process, and analyze real-time data from a plurality of sources to recover and rebuild the process in the areas affected by the disaster. It involves real-time contextualization, and intelligent decision-making to create a resilient framework for disaster preparedness, response, recovery, and prevention.

In one aspect of the present invention, a disaster recovery system facilitating recovery and rebuilding efforts in affected areas by integrating a computing unit with a plurality of data sources is disclosed. The plurality of data sources includes but is not limited to IoT devices, drones, autonomous vehicles, handheld devices, and public data streams. A central controller, connected to the computing unit, processes real-time data on property damage, environmental conditions, and infrastructure integrity. The real-time data includes data generated from a plurality of dynamic sources, such as live video feeds from drones, geospatial data from IoT sensors, real-time social media posts, environmental monitoring devices, and broadcast feeds, providing up-to-the-minute information on property damage, environmental conditions, and infrastructure status within the affected area. The disaster recovery system includes a data ingestion module that normalizes, aggregates, and stores data, and a contextualization module that extracts metadata and generates insights on the impacted area. A decision engine, equipped with a damage categorization module powered by machine learning, prioritizes damage severity and resource allocation. The disaster recovery system automates permit application generation, ensuring compliance with local regulations. Furthermore, a rapid permit processing module integrates with government agencies to expedite permit issuance. By assessing real-time damage and optimizing resource allocation, the disaster recovery system enhances disaster preparedness, response, and recovery, providing an efficient and coordinated approach to rebuilding efforts.

In another aspect of the present invention, a method for disaster recovery and rebuilding process in affected areas is disclosed. The disaster recovery method integrates a computing unit with a plurality of data sources. The plurality of data sources includes but is not limited to IoT devices, drones, autonomous vehicles, handheld devices, and public data streams. A communicable connection is established between a central controller and the computing unit to transfer a real-time data received from the plurality of data sources. The real-time data is received on property damage, environmental conditions, and infrastructure integrity. The real-time data includes data generated from a plurality of dynamic sources, such as live video feeds from drones, geospatial data from IoT sensors, real-time social media posts, environmental monitoring devices, and broadcast feeds, providing up-to-the-minute information on property damage, environmental conditions, and infrastructure status within the affected area. The received real-time data is detected, normalized, and aggregated and subsequently stored in a central repository. A metadata is extracted from the ingested data to generate insights on affected areas, including, environmental conditions, infrastructure integrity, and demographic impacts. Further, a communicable connection is established between a decision engine and the central controller to categorize and prioritize the severity of the damage using machine learning algorithms. Then, automatically pre-populated permit applications are generated that comply with local building codes and environmental regulations. Finally, automated compliance checks are performed and permit issuance is expedited by integrating with government agencies or municipal organizations.

In an aspect, the priority for quick recovery is given to the properties based on the contextual damage ratings.

In yet another aspect, the computing unit is accessible only to the authorized administrators.

Advantageously, a collaborative interface that enables seamless cooperation between diverse stakeholders, including local governments, emergency response agencies, urban planners, and environmental experts to facilitate unified efforts for smarter resource allocation and resilient rebuilding.

### BRIEF DESCRIPTION OF THE ACCOMPANYING DRAWINGS

The above-mentioned implementations are further described herein regarding the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 depicts an exemplary disaster recovery system for recovery and rebuilding processes in affected areas.

FIG. 2 depicts details of a plurality of data sources used to capture real-time data.

FIG. 3 depicts details of real-time data captured using the plurality of data sources.

FIG. 4 depicts details of handheld devices used to capture real-time localized data.

FIG. 5 depicts various sub-modules of computing unit.

FIG. 6 depicts various sub-modules of data receiving component.

FIG. 7 depicts various sub-modules of a central controller.

FIG. 8 depicts various sub-modules of a contextualization module.

FIG. 9 depicts various sub-modules of a damage categorization module.

FIG. 10 depicts various sub-modules of a permit application generator.

FIG. 11 depicts various sub-modules of a rapid permit processing module.

FIG. 12 depicts an exemplary disaster recovery method for recovery and rebuilding processes in affected areas.

### DETAILED DESCRIPTION

Embodiments, of the present disclosure, will now be described with reference to the accompanying drawing.

In the following description, certain specific details are outlined to provide a thorough understanding of various disclosed embodiments. However, one skilled in the relevant art will recognize that embodiments may be practiced without one or more of these specific details, or with other methods, components, materials, etc.

Unless the context indicates otherwise, throughout the specification and claims which follow, the word “comprises” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content dictates otherwise. It should also be noted that the term “or” is generally employed in its broadest sense, that is, as meaning “and/or” unless the content dictates otherwise.

A disaster recovery system facilitating recovery and rebuilding efforts in affected areas by integrating a computing unit with a plurality of data sources is disclosed. The plurality of data sources includes but is not limited to IoT devices, drones, autonomous vehicles, handheld devices, and public data streams. A central controller, connected to the computing unit, processes real-time data on property damage, environmental conditions, and infrastructure integrity. The real-time data includes data generated from a plurality of dynamic sources, such as live video feeds from drones, geospatial data from IoT sensors, real-time social media posts, environmental monitoring devices, and broadcast feeds, providing up-to-the-minute information on property damage, environmental conditions, and infrastructure status within the affected area. The disaster recovery system includes a data ingestion module that normalizes, aggregates, and stores data, and a contextualization module that extracts metadata and generates insights on the impacted area.

A decision engine, equipped with a damage categorization module powered by machine learning, prioritizes damage severity and resource allocation. The disaster recovery system automates permit application generation, ensuring compliance with local regulations. Furthermore, a rapid permit processing module integrates with government agencies to expedite permit issuance. By assessing real-time damage and optimizing resource allocation, the disaster recovery system enhances disaster preparedness, response, and recovery, providing an efficient and coordinated approach to rebuilding efforts.

The disaster recovery system offers significant advantages for disaster recovery and rebuilding processes by enabling real-time data integration from diverse sources such as IoT devices, drones, and social media, ensuring a comprehensive understanding of affected areas. The disaster recovery systems automated decision-making, powered by machine learning algorithms, categorizes and prioritizes damage severity, optimizing resource allocation and response efforts. By streamlining permit generation, automating compliance checks, and integrating with government systems, the disaster recovery system accelerates the rebuilding process while ensuring compliance with local regulations. Furthermore, the disaster recovery system enhances disaster preparedness and recovery by providing real-time insights, providing collaboration among stakeholders, and supporting informed, efficient decision-making for faster, more resilient recovery efforts.

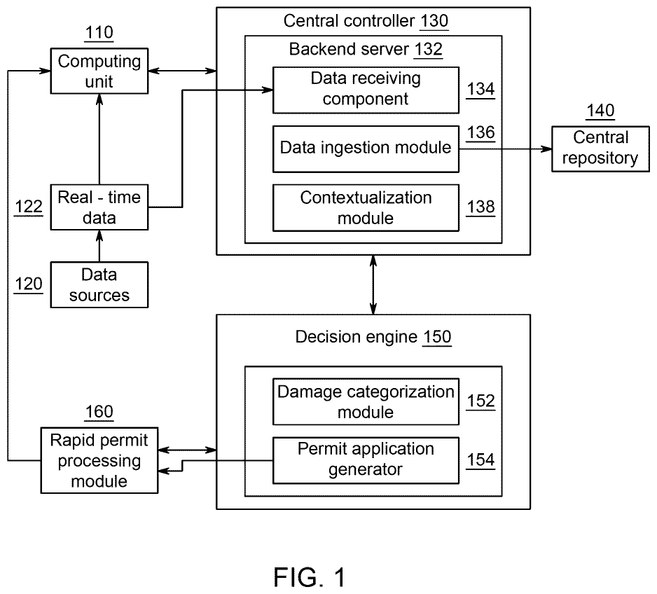

FIG. 1 depicts an exemplary disaster recovery system 100 for recovery and rebuilding processes in affected areas.

The disaster recovery system 100 described is a comprehensive and innovative system aimed at significantly enhancing the speed, accuracy, and coordination of recovery efforts in disaster-stricken areas. The disaster recovery system 100 integrates a plurality of data sources 120, advanced technologies, and automated processes, focusing on real-time damage assessment, resource allocation, and permit issuance to expedite rebuilding and recovery. The components involved are designed to ensure seamless communication, data integrity, and decision-making in the aftermath of catastrophic events, such as hurricanes, wildfires, earthquakes, and other natural disasters.

The foundation of the disaster recovery system 100 lies in its ability to collect and process data from the plurality of sources 120. A computing unit 110 is the core of the disaster recovery system 100, designed to integrate with the plurality of data sources 120 that provide real-time data 122 for assessing damage and coordinating recovery efforts. The plurality of data sources 120 are vast and varied, ranging from traditional sensors and devices to more modern tools like drones and autonomous vehicles. The plurality of data sources 120 includes Internet of Things (IoT) devices, drones, autonomous vehicles, handheld devices, and public data streams, each contributing different types of data 122 that are essential to understanding the scope of a disaster's impact.

For instance, IoT devices embedded in infrastructure such as bridges, buildings, and roads can provide real-time data 122 on structural integrity, indicating whether certain areas are at risk of collapse or if they need immediate attention. Drones equipped with high-resolution cameras and thermal sensors can provide aerial views of large disaster zones, helping to identify areas of extensive damage or hazardous conditions. Autonomous vehicles can be used to map roads and supply chains, while handheld devices used by city officials, first responders, and emergency teams can collect data on-site, such as photos, videos, and environmental readings, which are critical for localized assessments.

Public data streams, including social media posts and broadcast feeds, provide insights into the human impact of the disaster. The plurality of data sources 120 helps capture real-time sentiments, emergency reports, and community needs, allowing the disaster recovery system 100 to gather unfiltered information that may not be captured through traditional reporting methods. Together, these plurality of data sources 12 form a comprehensive view of the disaster, ensuring that the disaster recovery system 100 has up-to-the-minute information on property damage, environmental conditions, and infrastructure status.

A central controller 130 is the heart of the disaster recovery system 100, functioning as the point where all the collected real-time data 122 converge for processing, analysis, and decision-making. The central controller 130 houses a backend server 132 that communicates directly with the computing unit 110, ensuring that the disaster recovery system 100 can handle vast amounts of real-time data 122. The backend server 132 processes this real-time data 122 through a range of sub-modules designed to detect, normalize, and aggregate incoming data.

A data receiving component 134 of the backend server 132 plays a crucial role by receiving the real-time data 122 from all integrated sources 120 and feeding it into the data receiving component 134. The real-time data 122 includes live video feeds from drones, geospatial data from IoT sensors, and real-time social media posts that capture public sentiment and emergency needs. Environmental monitoring devices, such as weather stations, provide data on the changing conditions in disaster areas. Broadcast feeds from television and radio stations offer further context and insights into the disaster's progression.

In disaster-affected areas where traditional communication infrastructure is often damaged or unavailable, the computing unit 110 establishes portable private 5G networks. These networks ensure uninterrupted data transmission and communication across different recovery teams and agencies. They facilitate real-time information exchange between field workers, drones, central servers, and decision-makers, allowing for seamless coordination.

The computing unit 110 that controls this disaster recovery system 100 is accessible only by authorized administrators, ensuring that sensitive data is protected from unauthorized access. Security protocols and encryption are implemented to maintain the integrity and confidentiality of all data transmitted and received by the disaster recovery system 100.

Once the real-time data 122 has been received, the disaster recovery system 100 employs a data ingestion module 136 designed to detect, normalize, and aggregate the real-time data 122 before storing it in a central data repository 140. Data normalization ensures that the diverse sources of information are standardized to make them compatible for processing. For example, data from drones may be in different formats than information from IoT sensors or social media posts. The data ingestion module 136 harmonizes these formats to allow for a unified approach to data analysis.

Validation is an essential part of this process, ensuring that the incoming data 122 meets predefined standards of accuracy, completeness, and relevance to the disaster recovery effort. This ensures that only high-quality data 122 is used in the decision-making process, which is crucial in high-stakes disaster situations where errors can have severe consequences.

Once the data 122 is processed and stored, the central controller 130 uses a contextualization module 138 to extract metadata from the ingested data. Metadata refers to additional information that provides context to the raw data, helping to interpret it in a meaningful way. For example, metadata might include the time and location of a drone's footage or the environmental conditions at the moment a particular sensor reading was captured.

The contextualization module 138 analyzes the combined dataset to generate insights into the affected areas, focusing on environmental conditions, infrastructure integrity, and demographic impacts. For example, the contextualization module 138 might detect a correlation between areas with significant damage and locations with high population densities, indicating urgent needs for humanitarian assistance. The contextualization module 138 might also provide insights into areas where infrastructure, such as bridges or roads, has been severely compromised, helping recovery teams prioritize repairs.

Additionally, the contextualization module 138 uses geospatial data to track the progress of recovery efforts and ensure that rebuilding aligns with pre-disaster urban planning initiatives. This allows the disaster recovery system 100 to identify areas where recovery efforts might not align with the city's long-term development plans and adjust the rebuilding strategies accordingly.

A key component of the disaster recovery system 100 is a decision engine 150, which is communicably connected to the central controller 130. The decision engine 150 plays a pivotal role in processing the data and generating actionable decisions. A damage categorization module 152, integrated within the decision engine 150 uses machine learning algorithms to assess and prioritize the severity of damage to buildings, infrastructure, and the environment.

The damage categorization module 152 allocates a contextual damage rating to each area based on the severity of the damage observed. Areas with more extensive destruction, such as collapsed buildings or damaged power grids, will be rated higher in terms of priority. This contextual damage rating is then used to determine where recovery efforts should be focused first, ensuring that resources are allocated efficiently and effectively.

The decision engine 150 also automates the process of permit application generation using a permit application generator 154. The permit application generator 154 is programmed to create pre-populated permit applications that comply with local building codes and environmental regulations. This reduces the manual effort required to process permits, speeds up the rebuilding process, and ensures that all recovery efforts are in compliance with relevant regulations.

Once permit applications are generated, they are automatically checked for compliance using a rapid permit processing module 160. The rapid permit processing module 160 integrates with government agencies or municipal organizations to automate compliance checks and expedite the permit issuance process. As a result, the administrative burden is significantly reduced, and recovery teams can begin work without delay.

A unique aspect of the disaster recovery system 100 is its collaborative interface, which enables seamless cooperation between diverse stakeholders, including local governments, emergency response agencies, urban planners, and environmental experts. This interface ensures that all parties have access to real-time, contextual data, allowing them to coordinate efforts, allocate resources efficiently, and make informed decisions about recovery and rebuilding.

For example, a government agency may be responsible for overseeing infrastructure repairs, while emergency response teams focus on providing medical aid to affected populations. The collaborative interface ensures that these teams work with a shared understanding of priorities and available resources, improving the overall effectiveness of the recovery effort.

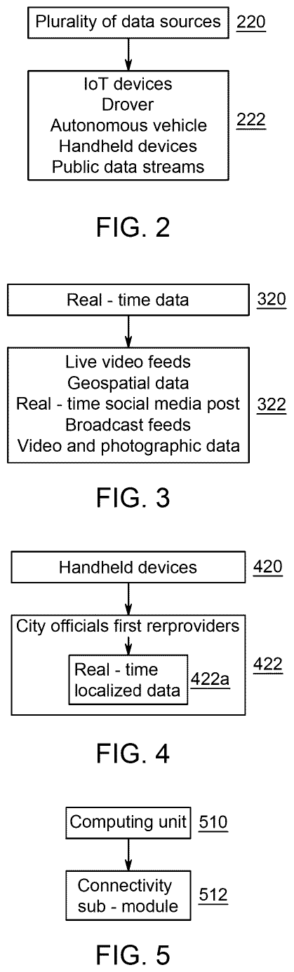

FIG. 2 depicts details of a plurality of data sources 220 used to capture real-time data.

The disaster recovery system relies on the plurality of data sources 220 to capture real-time contextual data that is important for effectively assessing and responding to disasters. The plurality of data sources 220 are diverse and encompass many technologies that capture localized, dynamic information from multiple angles, enabling comprehensive situational awareness. The plurality of data sources 220 includes a varied range of sources 222, but is not limited to, IoT devices, drones, autonomous vehicles, handheld devices, and public data streams such as social media, news feeds, and broadcast data. Each of these varied range of sources 222 contributes unique forms of data that, when integrated, provide a complete and more accurate picture of the disaster's impact.

The IoT (Internet of Things) devices are embedded sensors placed in key locations like buildings, roads, and bridges. These sensors monitor environmental parameters such as air quality, temperature, seismic activity, and structural integrity in real-time. For example, during an earthquake, IoT devices embedded in a building can detect vibrations and shifts in structural alignment, transmitting this data to the central controller. This allows emergency responders to assess building stability and prioritize evacuation routes based on real-time conditions.

The drones are used to capture aerial imagery and video footage of disaster zones, especially in areas that are too dangerous or inaccessible for humans. Equipped with high-resolution cameras and other sensors, drones can fly over devastated areas, providing detailed visual data that is geotagged with precise location information. For example, a drone flying over a flood zone can provide real-time footage of submerged areas, helping decision-makers determine which parts of the city need immediate attention or evacuation. The drones can also use thermal imaging to detect hot spots or fires, which can be critical for firefighting teams on the ground.

The autonomous vehicles include self-driving cars and trucks, are another valuable data source. The autonomous vehicles are equipped with a wide array of sensors such as cameras, LIDAR, and radar, allowing them to capture detailed data about road conditions, traffic patterns, and obstacles in real-time. For instance, an autonomous vehicle driving through a disaster-affected city can detect roadblock locations, damaged infrastructure, and areas with high concentrations of people, transmitting this data to a central system for resource planning and logistics.

The handheld devices, such as smartphones and tablets, are commonly used by first responders and city officials to capture real-time data. These devices are equipped with GPS, cameras, and other sensors that allow users to document specific incidents or assess damage. For example, a firefighter using a tablet could take a photo of a collapsed building, geotag it with the device's GPS, and upload the image to a central controller for immediate analysis. These handheld devices also enable communication between field personnel and command centers, providing continuous updates and situational awareness.

The public data streams refer to data that is publicly available, such as social media posts, news broadcasts, and weather reports. Social media platforms like Twitter and Facebook, for example, provide real-time updates from residents, volunteers, and news outlets during a disaster. These posts, which often include geotagged images, videos, and text, provide invaluable on-the-ground insights about areas not yet reached by responders. Additionally, weather data from public meteorological agencies helps forecast the progression of storms or wildfires, which can significantly influence response strategies.

The real strength of the plurality of data sources 220 lies in how they are contextually integrated to form a comprehensive understanding of the disaster's impact. Contextual data refers to data that is not just raw information, but is enriched with metadata and analyzed to make it meaningful in the context of the disaster. For example, real-time data from drones, IoT devices, and handheld devices are combined to assess environmental conditions, infrastructure damage, and demographic impacts simultaneously.

By combining data from IoT sensors monitoring air quality, drones capturing imagery of damaged areas, and handheld devices documenting firsthand observations, the disaster recovery system generates a multi-dimensional view of the disaster's scope. For instance, if drones capture flooding in a neighborhood, IoT devices may provide data on water levels, while social media streams might report personal accounts of evacuations and blockages. Together, this data creates a contextualized understanding of the situation, highlighting priority areas for intervention and ensuring a timely, coordinated response.

The disaster recovery system uses this contextual data to generate actionable insights that are specific to the disaster, allowing decision-makers to prioritize recovery efforts, allocate resources, and adjust strategies dynamically as new data flows in. For example, real-time damage assessments can help determine which buildings are safe to enter, and contextual data can guide the deployment of emergency responders or relief efforts to areas with the highest need.

The integration of the plurality of data sources 220 allows the disaster recovery system to rapidly collect, process, and analyze real-time data from diverse channels. This contextualized, multi-source data forms the backbone of a resilient disaster recovery system, enabling faster, more informed decision-making that directly supports recovery and rebuilding efforts.

FIG. 3 depicts details of real-time data 320 captured using the plurality of data sources.

The real-time data 320 captured by the plurality of data sources contributes unique information that is vital for disaster response, recovery, and rebuilding. The plurality of sources work in tandem to provide up-to-the-minute updates on various critical factors such as property damage, environmental conditions, and the status of infrastructure within disaster-affected areas. The integration of real-time data 320 from the plurality of sources ensures that decision-makers have a comprehensive understanding of the situation, allowing them to respond promptly and effectively.

The different type 322 of the real-time data 320 include, but is not limited to, live video feeds, geospatial data, real-time social media post, broadcast feeds, and video and photographic data.

One of the primary sources of the real-time data 320 is live video feeds from drones. Drones are deployed in disaster zones to capture aerial footage and high-resolution imagery, which are essential for providing real-time visual information of the ground conditions. For instance, drones flying over flooded areas can capture video footage showing submerged roads, buildings, and other infrastructure. These videos, paired with geospatial data, help responders to assess the scale of damage and identify areas that require immediate attention. For example, a drone capturing real-time footage of an earthquake-ravaged area can instantly relay the information to a central system for processing, guiding rescue teams to high-risk zones.

Another critical source of the real-time data 320 comes from geospatial data provided by IoT sensors. These sensors are installed in various locations such as buildings, roads, bridges, and environmental monitoring stations to capture ongoing environmental changes and structural conditions. IoT sensors may measure seismic shifts, air quality, temperature, or even stress on infrastructure. For example, an IoT sensor placed in a building could monitor structural movements caused by aftershocks in the wake of an earthquake. By providing real-time geospatial data, these sensors help determine the safety of buildings and roads, contributing to quicker damage assessments and recovery efforts.

In addition to these physical sensors, real-time social media posts and public broadcasts serve as valuable real-time data 320. During a disaster, citizens, first responders, and journalists often post real-time updates to social media platforms like Twitter, Facebook, and Instagram, sharing images, videos, and descriptions of the events as they unfold. These posts, which often include location tags, provide on-the-ground perspectives that are not always captured by the plurality of data sources. For instance, social media posts may report locations of traffic jams due to flooding or offer updates on areas experiencing power outages. These contributions can also include videos and photographs showing destruction, helping to fill in gaps that official responders may not yet have reached. Social media can be a vital supplement to more formal data, offering insights into citizen needs and localized conditions.

Environmental monitoring devices are also crucial in capturing real-time data related to environmental conditions such as air quality, temperature, and atmospheric pressure. For example, during a wildfire, devices that measure particulate matter in the air can provide real-time data on air quality, helping emergency teams decide where to deploy air filtration systems or issue evacuation orders. Such environmental data helps officials understand the broader impact of the disaster on public health and safety.

Lastly, broadcast feeds from television and radio stations provide real-time updates on disaster progress and government instructions. These feeds often include live coverage of the disaster area, weather reports, and updates from emergency management agencies. For instance, a live broadcast from a storm-ravaged area can offer a continuous stream of information about road closures, rescue operations, and shelter availability. Broadcast data helps consolidate information from diverse regions, ensuring that all stakeholders stay informed about developments across large geographical areas.

The real-time data 320 is the contextual data that enriches and interprets the raw data from the plurality of sources to derive meaningful insights. Simply put, it's not just about collecting individual data points; it's about combining them in a way that provides a comprehensive, situationally aware understanding of the disaster's scope and impact. Contextual data includes both real-time data 320 and historical data, and it is processed and analyzed to ensure that the information is actionable.

For example, the combination of drone footage showing flood damage, IoT sensor readings monitoring water levels, social media posts documenting people trapped in flooded homes, and broadcast feeds describing regional road closures provides a full picture of the disaster. When analyzed together, this data creates contextual understanding, allowing decision-makers to prioritize areas for rescue, assess the need for emergency shelters, and deploy resources where they are most urgently needed.

In addition, contextual data can be used for predictive analysis. By analyzing historical data, such as past flooding patterns or building stability records, along with real-time data 320, the disaster recovery system can forecast potential outcomes or anticipate further risks. For example, if IoT sensors indicate that a bridge is structurally compromised, and live video feeds show rising floodwaters in the area, the contextualized data can predict the likelihood of the bridge collapsing and trigger an automated response to divert traffic or deploy additional safety measures.

The real-time data 320 captured from the plurality of sources such as drones, IoT sensors, social media posts, environmental devices, and broadcast feeds forms the backbone of this disaster recovery system. By integrating these data streams, the disaster recovery system not only provides a current snapshot of the disaster's impact but also generates contextual data that supports informed decision-making. The ability to contextualize this data enables more effective response, faster recovery, and improved long-term disaster preparedness.

FIG. 4 depicts details of handheld devices 420 used to capture real-time localized data 422a.

In disaster response and recovery efforts, the handheld devices 420 used by city officials and first responders are indispensable for capturing real-time localized data 422a directly from affected areas. The handheld devices 420, including smartphones, tablets, and ruggedized handheld units, are equipped with advanced features such as high-resolution cameras, GPS modules, and real-time connectivity, enabling them to document on-the-ground conditions with exceptional accuracy. By utilizing these capabilities, responders can collect geotagged images, videos, and environmental data, which are essential for assessing the severity of damage, prioritizing resources, and coordinating response efforts.

The handheld devices 420 receive the data from various sources 422, including, but not limited to, city officials, and first responders.

For instance, a city official surveying a collapsed building can use a handheld device 420 to capture geotagged photographs of the structure. These images, combined with GPS coordinates, provide precise location information and visual documentation, which is automatically transmitted to the central repository for analysis. Similarly, during a wildfire, first responders equipped with the handheld devices 420 can measure air quality, temperature, and humidity levels using built-in environmental sensors. This data helps determine whether it is safe to deploy personnel in certain areas or if evacuation orders need to be issued.

In addition to static data, the handheld devices 420 enable the transmission of real-time video feeds, allowing command centers to view live footage of the disaster zone. For example, a firefighter streaming live video from a burning building can provide decision-makers with critical situational awareness, enabling them to issue directives without delay. The handheld devices 420 also facilitate communication between field teams and central operations, ensuring that updates and instructions are shared instantly.

The use of handheld devices 420 by city officials and first responders ensures a rapid and accurate flow of the real-time localized data 422a, enhancing the overall efficiency of disaster response. By providing a real-time view of the situation on the ground, the handheld devices 420 empower stakeholders to make informed decisions, allocate resources effectively, and accelerate recovery efforts.

FIG. 5 depicts various sub-modules of computing unit 510.

A connectivity sub-module 512 of the computing unit 510 plays a critical role in ensuring seamless and reliable communication in disaster-affected areas where conventional communication infrastructure may be damaged or entirely unavailable. The connectivity sub-module 512 is specifically adapted to establish portable private 5G networks, which serve as a robust and high-speed communication backbone during disaster response and recovery operations.

The primary function of the connectivity sub-module 512 is to create an independent, portable communication network capable of handling large volumes of data transmission in real-time. By utilizing advanced 5G technology, the connectivity sub-module 512 enables low-latency and high-bandwidth connections, ensuring uninterrupted communication between field devices, drones, IoT sensors, and the central controller. This capability is particularly vital in scenarios where time-sensitive decisions must be made based on rapidly changing on-ground conditions.

The connectivity sub-module 512 is designed to be easily deployable in disaster zones, offering flexibility and scalability to adapt to the specific needs of the affected area. The connectivity sub-module 512 can quickly establish a localized network that supports a wide range of connected devices, such as autonomous vehicles, handheld devices, and environmental monitoring sensors. This ensures that all critical systems and personnel remain connected, even in remote or infrastructure-compromised locations.

Additionally, the connectivity sub-module 512 enhances collaboration among various stakeholders involved in disaster recovery, including emergency response teams, government agencies, and utility providers. The 5G network enables real-time data sharing and communication, facilitating coordinated efforts and efficient resource allocation. The connectivity sub-module 512 also supports secure data transmission, employing encryption and authentication protocols to maintain the integrity and confidentiality of sensitive information.

The connectivity sub-module 512 ensures reliable and high-speed communication during disaster recovery operations. The ability of the connectivity sub-module 512 to establish portable private 5G networks makes it an indispensable component of the computing unit 510, supporting real-time data transmission, enhanced coordination, and efficient disaster management in challenging environments.

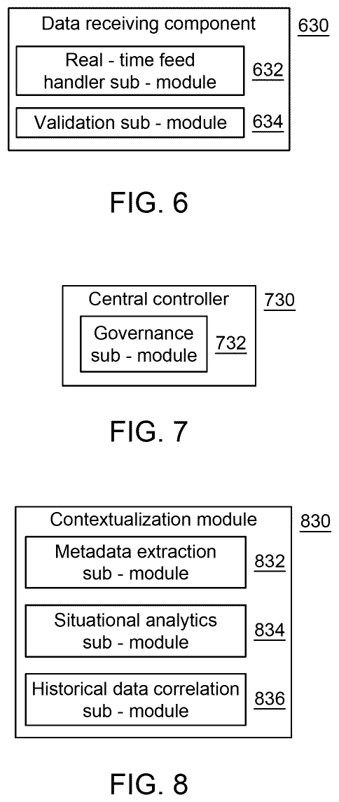

FIG. 6 depicts various sub-modules of data receiving component 630.

The data receiving component 630 is an important component of the disaster recovery system, responsible for collecting and processing the real-time data from the plurality of sources in real-time. The data receiving component 630 is equipped with advanced sub-modules, including a real-time feed handler sub-module 632 and a validation sub-module 634, each of which performs specific functions to ensure the efficiency, reliability, and integrity of the data collection process.

The real-time feed handler sub-module 632 is specifically designed to manage the ingestion of real-time data from the plurality of sources, including drones, IoT devices, autonomous vehicles, and handheld devices. The real-time feed handler sub-module 632 captures geospatially-tagged high-resolution imagery, video feeds, and sensor data to provide a comprehensive and dynamic representation of the disaster-affected area.

The geospatial tagging feature allows every piece of the real-time data to be precisely linked to its geographic location, enabling the disaster recovery system to map damage and environmental conditions with pinpoint accuracy. High-resolution imagery and video feeds contribute to detailed visual assessments, while sensor data provides additional quantitative insights, such as temperature, humidity, air quality, and structural stability.

The real-time feed handler sub-module 632 ensures that the captured real-time data are continuously transmitted to the central controller with minimal latency. This ensures that time-sensitive decisions, such as resource allocation and damage prioritization, can be made effectively based on the most current data.

The validation sub-module 634 is tasked with verifying the integrity and accuracy of the real-time data received by the real-time feed handler sub-module 632. Since disaster zones often present challenging conditions for data collection, including signal disruptions, environmental interference, and the risk of incomplete or corrupted data, the validation sub-module 634 plays a critical role in maintaining the reliability of the disaster recovery system.

The validation process involves checking the incoming data against predefined criteria, such as format, completeness, and consistency with other datasets. For example, the validation sub-module 634 ensures that geospatial tags match the expected geographic boundaries of the affected area and that sensor readings fall within realistic ranges. If any anomalies, errors, or inconsistencies are detected, the validation sub-module 634 flags the data for further review or rejection, preventing unreliable information from influencing critical decisions.

The real-time feed handler sub-module 632 and the validation sub-module 634 ensure that the data receiving component 630 operates with a high level of precision and dependability. While the real-time feed handler sub-module 632 ensures continuous and comprehensive data collection, the validation sub-module 634 ensures that only accurate, trustworthy data is processed further by the disaster recovery system.

FIG. 7 depicts various sub-modules of a central controller 730.

The central controller 730 is the core component of the disaster recovery system, arranging data processing, analysis, and decision-making. Among its various sub-modules, a governance sub-module 732 plays a pivotal role in ensuring the integrity, compliance, and security of the data handled by the disaster recovery system. The governance sub-module 732 is specifically adapted to enforce robust data governance policies, which are critical for maintaining trust, accountability, and adherence to regulatory standards in disaster recovery operations.

The governance sub-module 732 is responsible for implementing and managing policies that govern how the real-time data is collected, stored, processed, and shared within the disaster recovery system. In the context of disaster recovery, where sensitive information such as personal data, property damage assessments, and geospatial details are involved, the governance sub-module 732 ensures that all operations comply with relevant regulatory standards such as data protection laws, privacy regulations, and industry best practices.

A key feature of the governance sub-module 732 is its ability to utilize blockchain-enabled audit trails to maintain a transparent and tamper-proof record of all data transactions and system activities. This functionality provides an immutable ledger that records when, how, and by whom data was accessed, modified, or shared. By implementing blockchain technology, the governance sub-module 732 ensures that the disaster recovery system operates with full accountability and traceability, reducing the risk of data breaches, unauthorized access, or misuse.

The governance sub-module 732 also automates compliance checks by validating data handling practices against predefined regulatory requirements. For example, the governance sub-module 732 can enforce rules related to data retention periods, ensure anonymization of sensitive data, and monitor access permissions to prevent unauthorized entities from accessing critical information. This reduces the manual burden on administrators and minimizes the potential for human error.

In addition, the governance sub-module 732 ensures seamless collaboration between multiple stakeholders, including government agencies, municipal organizations, and private entities, by defining clear protocols for data sharing and access. These protocols help maintain the confidentiality and integrity of the data while promoting efficient cooperation during disaster recovery efforts.

The governance sub-module 732 provides several key benefits:
Regulatory Compliance: Ensures adherence to local, national, and international data protection and privacy laws.
Enhanced Transparency: Blockchain-enabled audit trails create a clear and unalterable record of all system activities.
Data Integrity: Prevents unauthorized modifications to data, ensuring accuracy and reliability.
Operational Accountability: Tracks system usage and decisions to identify potential issues and improve oversight.
Streamlined Processes: Automates compliance enforcement, reducing administrative overhead and improving efficiency.

The governance sub-module 732 is an essential component of the central controller 730, safeguarding the ethical, secure, and compliant use of data in disaster recovery operations. Its advanced features ensure that the disaster recovery system remains trusted and reliable tool for stakeholders, while its automation capabilities drive operational efficiency in challenging scenarios.

FIG. 8 depicts various sub-modules of a contextualization module 830.

The contextualization module 830 transforms raw data into actionable insights by analyzing it within its broader situational and historical context. The contextualization module 830 is designed to process and interpret diverse data to generate a comprehensive understanding of disaster-affected areas. The contextualization module 830 achieves this through its advanced sub-modules, including a metadata extraction sub-module 832, a situational analytics sub-module 834, and a historical data correlation sub-module 836, each which addresses specific aspects of contextualization to enhance decision-making.

The metadata extraction sub-module 832 plays a foundational role in ensuring that data ingested by the disaster recovery system is enriched with metadata tags for better organization and contextual understanding. Metadata tags include information such as timestamps, geospatial coordinates, device identifiers, and data source attributes. By associating these tags with the raw data, the disaster recovery system gains a structured and searchable dataset that can be efficiently analyzed.

For example, when drone footage or sensor readings are ingested, the metadata extraction sub-module 832 attaches tags identifying the exact location, time of capture, and type of data (e.g., video, temperature readings). This tagging process ensures that every piece of data is contextualized within its operational environment, facilitating precise analysis and integration with other datasets.

The situational analytics sub-module 834 is responsible for deriving real-time insights about the disaster-affected area. The situational analytics sub-module 834 analyzes ingested data to assess critical parameters such as environmental conditions, infrastructure integrity, and demographic impacts. This involves interpreting high-resolution imagery, video feeds, and sensor readings to identify areas of significant damage, potential hazards, and population needs.

For instance, the situational analytics sub-module 834 can evaluate the structural integrity of buildings by analyzing visual data, identify flooded areas using geospatial overlays, or detect air quality issues through sensor data. The situational analytics sub-module 834 can also generate demographic insights by analyzing public data streams, such as social media posts, to identify affected populations and prioritize rescue and relief efforts accordingly. These insights enable stakeholders to understand the immediate and localized impact of a disaster, supporting effective decision-making.

The historical data correlation sub-module 836 enhances the system's analytical capabilities by integrating historical datasets with real-time data for predictive analysis. The historical data correlation sub-module 836 compares current conditions with historical patterns, such as past disaster impacts, weather data, and rebuilding efforts, to forecast potential developments and recommend proactive measures.

For example, if a region has a history of flooding due to specific rainfall thresholds, the historical data correlation sub-module 836 can predict the likelihood of further flooding based on current rainfall data. Similarly, the historical data correlation sub-module 836 can assess the effectiveness of previous rebuilding strategies in similar scenarios to recommend optimal approaches for long-term recovery. By correlating historical and real-time data, the historical data correlation sub-module 836 enables the disaster recovery system to anticipate risks, allocate resources efficiently, and design resilient infrastructure.

The contextualization module 830 as a whole provides several critical advantages:
Enhanced Understanding: Combines metadata, situational insights, and historical context to generate a holistic view of disaster scenarios.
Improved Decision-Making: Offers actionable insights tailored to the specific needs of affected areas.
Proactive Planning: Enables predictive analytics to mitigate future risks and enhance disaster preparedness.
Resource Optimization: Prioritizes relief efforts based on real-time and historical insights.

The metadata extraction sub-module 832, situational analytics sub-module 834, and historical data correlation sub-module 836 work in concert within the contextualization module 830 to deliver a comprehensive and nuanced understanding of disaster scenarios.

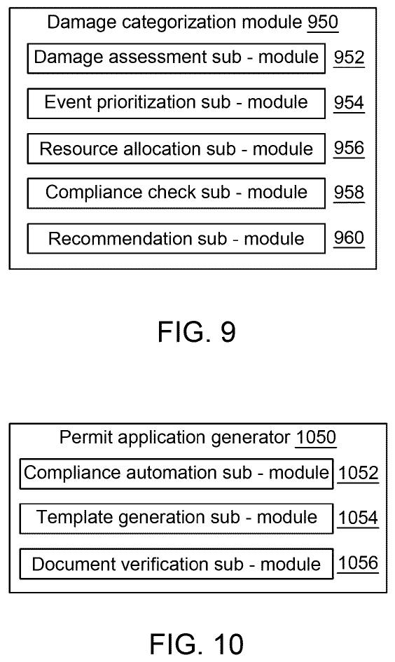

FIG. 9 depicts various sub-modules of a damage categorization module 950.

The damage categorization module 950 is a sophisticated component of the disaster recovery system designed to evaluate, prioritize, and address the damage in disaster-affected areas. The sub-modules of the damage categorization module 950 collaborate to ensure that recovery efforts are efficient, compliant with regulations, and focused on long-term resilience. The various sub-modules of the damage categorization module 950 include damage assessment sub-module 952, an event prioritization sub-module 954, a resource allocation sub-module 956, a compliance check sub-module 958, and a recommendation sub-module 960, each fulfilling a distinct yet interrelated function.

The damage assessment sub-module 952 utilizes machine learning algorithms to analyze real-time data from sources such as drones, IoT devices, and high-resolution imagery. The damage assessment sub-module 952 categorizes the severity of damage to properties, infrastructure, and the environment. By identifying patterns and anomalies in data, such as structural damage, collapsed roads, or flooded areas, the damage assessment sub-module 952 assigns severity ratings to specific locations or assets. This automated assessment ensures speed and accuracy, enabling a rapid response to critical areas while minimizing the risk of human error.

For instance, the damage assessment sub-module 952 might classify damage into categories like minor, moderate, and severe, allowing recovery teams to focus their efforts on the most affected regions first.

The event prioritization sub-module 954 ranks affected areas or events based on urgency and resource requirements. This involves considering multiple factors, such as population density, environmental risks, and the availability of critical infrastructure. By analyzing these parameters, the event prioritization sub-module 954 identifies areas where intervention is most needed and creates a priority list for stakeholders. For example, an area with severe damage to a hospital or school may be ranked higher than a less critical location with similar structural damage. This prioritization ensures that resources are directed to the areas with the highest impact on safety, well-being, and recovery progress.

The resource allocation sub-module 956 is designed to recommend and prioritize the deployment of resources, such as personnel, equipment, and materials, based on the severity of damage and contextual insights. By integrating data from the damage assessment sub-module 952 and the event prioritization sub-module 954, the resource allocation sub-module 956 ensures that limited resources are used efficiently. For example, the resource allocation sub-module 956 can recommend sending more rescue teams to densely populated areas while allocating equipment for structural repairs to less urgent regions.

Additionally, the resource allocation sub-module 956 dynamically adjusts its recommendations based on real-time updates, ensuring that resources are reallocated as new data becomes available.

The compliance check sub-module 958 ensures that recovery and rebuilding efforts adhere to local building codes and environmental regulations. The compliance check sub-module 958 reviews permit applications, proposed rebuilding plans, and resource deployment strategies against regulatory standards. By automating compliance checks, the compliance check sub-module 958 reduces administrative delays and ensures that recovery efforts align with legal and environmental requirements. For instance, the compliance check sub-module 958 may flag a rebuilding plan that violates zoning laws or recommend adjustments to meet green building standards.

This functionality helps avoid costly legal issues and ensures that recovery efforts contribute to long-term sustainability.

The recommendation sub-module 960 provides strategic suggestions for rebuilding that enhance resilience against future disasters. Using insights from the other sub-modules and historical data, the recommendation sub-module 960 offers recommendations on construction materials, architectural designs, and infrastructure improvements. For example, in flood-prone areas, the recommendation sub-module 960 might suggest elevated structures or flood-resistant materials, while in earthquake zones, it may recommend seismic-resistant building designs. These recommendations aim to not only repair the damage but also improve the affected area's ability to withstand future disasters, creating safer and more resilient communities.

The damage categorization module 950 integrates advanced technologies and data-driven insights to manage disaster recovery comprehensively. The damage assessment sub-module 952 evaluates the severity of the damage, the event prioritization sub-module 954 ranks areas based on urgency, the resource allocation sub-module 956 optimizes the deployment of resources, the compliance check sub-module 958 ensures adherence to regulations, and the recommendation sub-module 960 focuses on resilient rebuilding strategies.

FIG. 10 depicts various sub-modules of a permit application generator 1050.

The permit application generator 1050 is an integral part of the disaster recovery system, designed to streamline the process of permit issuance for reconstruction and rebuilding efforts. By automating complex administrative tasks, the permit application generator 1050 significantly reduces the time and effort required to obtain necessary approvals. The permit application generator 1050 achieves this through its specialized sub-modules, namely, a compliance automation sub-module 1052, a template generation sub-module 1054, and a document verification sub-module 1056. Each sub-module works collaboratively to ensure that permit applications are accurate, compliant, and tailored to the specific needs of disaster-affected areas.

The compliance automation sub-module 1052 is responsible for verifying that permit applications conform to local building codes and environmental regulations. The compliance automation sub-module 1052 utilizes an extensive database of legal and regulatory requirements, enabling it to automatically check for compliance during the generation of pre-populated applications. For instance, the compliance automation sub-module 1052 cross-references proposed rebuilding plans with zoning laws, safety standards, and environmental impact assessments.

By identifying potential violations early in the process, the compliance automation sub-module 1052 helps avoid delays or rejections, ensuring that applications submitted to authorities meet all requirements. For example, in areas prone to earthquakes, the compliance automation sub-module 1052 might ensure that structural designs comply with seismic-resistance standards, while in flood-prone regions, the compliance automation sub-module 1052 could validate the inclusion of flood mitigation features.

The template generation sub-module 1054 dynamically creates permit applications based on the specific damage scenarios encountered in disaster-affected areas. The template generation sub-module 1054 uses the data from the damage assessment module and the contextualization module to customize templates that align with the type and extent of damage. For instance, the template generation sub-module 1054 can generate distinct templates for residential repairs, commercial rebuilding, or infrastructure reconstruction, each pre-filled with relevant details such as location, damage severity, and required permits.

The adaptability of the template generation sub-module 1054 ensures that each application is in correspondence to the unique requirements of the project, reducing the need for manual intervention and minimizing the risk of errors or omissions. Additionally, the template generation sub-module 1054 simplifies the process for stakeholders by pre-filling information such as geospatial coordinates, local regulations, and project specifications.

The document verification sub-module 1056 ensures the accuracy and validity of submitted permit applications. The document verification sub-module 1056 cross-checks all submitted documentation, including identity proofs, ownership records, and supporting technical drawings, against verified databases and system-generated data. By validating these inputs, the document verification sub-module 1056 prevents fraudulent or incomplete applications from advancing in the approval process.

For example, the document verification sub-module 1056 can verify ownership details by matching submitted records with government databases or confirm the authenticity of architectural plans by checking for certified stamps or signatures. This automated verification process not only reduces administrative workloads but also builds trust and transparency within the permit issuance system.

The permit application generator 1050 and its sub-modules work in unity to create a seamless, efficient, and reliable process for permit generation and validation. The compliance automation sub-module 1052 ensures adherence to local regulations, the template generation sub-module 1054 dynamically creates application templates in correspondence to specific damage scenarios, and the document verification sub-module 1056 validates the accuracy and authenticity of submitted documents.

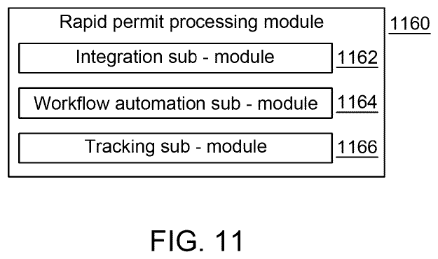

FIG. 11 depicts various sub-modules of a rapid permit processing module 1160.

The rapid permit processing module 1160 is an important component of the disaster recovery system, designed to accelerate the issuance of permits required for rebuilding and reconstruction in disaster-affected areas. By utilizing advanced automation, real-time integration, and tracking capabilities, the rapid permit processing module 1160 significantly reduces administrative delays and ensures a seamless experience for stakeholders. The rapid permit processing module 1160 achieves its efficiency through three specialized sub-modules, namely, an integration sub-module 1162, a workflow automation sub-module 1164, and a tracking sub-module 1166. Each plays a crucial role in streamlining the permit processing lifecycle.

The integration sub-module 1162 is designed to interface directly with government systems and municipal platforms to enable real-time permit processing. The integration sub-module 1162 ensures that the permit application process is synchronized with relevant governmental databases and workflows, allowing for immediate compliance checks, verification of supporting documents, and validation of application data.

For instance, the integration sub-module 1162 can retrieve local zoning laws, building codes, and environmental regulations directly from government servers to confirm that submitted applications meet all necessary criteria. The integration sub-module 1162 can also push approved permits back into the government system for seamless record-keeping. This real-time connectivity minimizes manual interventions, reduces back-and-forth communication, and ensures that the permit issuance process remains up-to-date and compliant with official standards.

The workflow automation sub-module 1164 is responsible for streamlining approval processes by automating repetitive administrative tasks. This includes routing applications to appropriate officials for review, generating notifications for pending approvals, and ensuring that all required steps are completed in the correct order.

For example, once an application is submitted, the workflow automation sub-module 1164 automatically assigns it to the relevant department based on the type of permit requested, such as residential, commercial, or infrastructure rebuilding. The workflow automation sub-module 1164 then tracks the application's progress through predefined workflows, ensuring that approvals, rejections, or requests for additional information are handled promptly and efficiently. This automation reduces bottlenecks, ensures consistency in decision-making, and allows human reviewers to focus on more complex evaluations.

The tracking sub-module 1166 provides stakeholders with real-time updates on the status of their permit applications. This includes information on whether an application has been submitted, is under review, has been approved, or requires additional documentation. The tracking sub-module 1166 offers a user-friendly dashboard or notification system that enables applicants, government officials, and system administrators to monitor the progress of applications at a glance.

For instance, applicants can receive updates through email or mobile notifications, informing them of key milestones such as submission confirmation, review initiation, or final approval. This transparency not only enhances user satisfaction but also fosters trust in the permit processing system by eliminating uncertainty and reducing the need for manual follow-ups.

The rapid permit processing module 1160 integrates seamlessly with governmental systems and automates key aspects of the permit issuance process, ensuring faster and more efficient approvals. The integration sub-module 1162 connects the disaster recovery system with official platforms for real-time data exchange and compliance verification. The workflow automation sub-module 1164 optimizes the processing pipeline by automating routine administrative tasks, while the tracking sub-module 1166 enhances transparency and user engagement through real-time status updates.

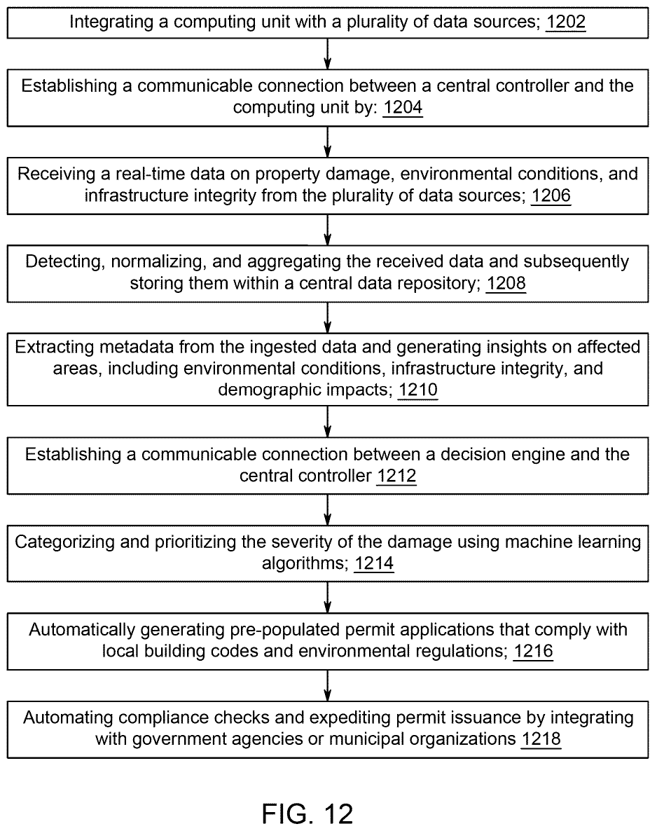

FIG. 12 depicts an exemplary disaster recovery method 1200 for recovery and rebuilding processes in affected areas.

Step 1202 integrates a computing unit with a plurality of data sources.

The disaster recovery process 1200 begins by integrating a computing unit with a plurality of data sources to facilitate comprehensive disaster assessment and response. This computing unit acts as the central hub, capable of interfacing with a variety of input streams, ensuring seamless data collection and processing.

The plurality of data sources includes Internet of Things (IoT) devices, which provide real-time sensor data on environmental conditions such as temperature, humidity, air quality, and structural vibrations that indicate infrastructure stress. Drones contribute high-resolution imagery and video, offering an aerial perspective of affected areas to identify damage, map inaccessible zones, and monitor ongoing recovery efforts. Autonomous vehicles play a key role by navigating through disaster-stricken areas to collect geospatial data, capture localized environmental information, and deliver supplies or equipment. Handheld devices, used by first responders and city officials, allow for the manual input and real-time transmission of localized observations, ensuring the capture of critical data that may not be detectable by automated systems. Additionally, the public data streams such as social media posts, broadcast feeds, and open-source environmental reports are utilized to gather unstructured yet valuable insights from the public and media sources.

By aggregating the real-time data from the plurality of sources, the computing unit creates a complete understanding of the disaster's impact, enabling the disaster recovery system to generate actionable insights for decision-making, prioritize resource allocation, and facilitate rapid recovery efforts. This integration ensures real-time situational awareness and supports an adaptive response to complex disaster scenarios.

Step 1204 establishes a communicable connection between a central controller and the computing unit.

Establishing a robust communicable connection between the central controller and the computing unit is done to ensure seamless data exchange and operational coordination during disaster recovery efforts. The central controller acts as the command center, managing and processing incoming real-time data from the computing unit, which is aggregated information from the plurality of sources, such as IoT devices, drones, and other sensors. This connection is fortified by deploying portable private 5G networks in disaster-affected areas, a critical step to address the challenges posed by damaged or unavailable traditional communication infrastructure. These portable networks provide high-speed, low-latency connectivity, enabling uninterrupted data transmission between field devices, drones, and the central controller, even in the most remote or severely impacted locations.

The setup ensures real-time communication and synchronization, which are vital for assessing damage, coordinating resources, and making informed decisions. To maintain the security and integrity of the system, access to the computing unit is strictly limited to authorized administrators. This controlled access minimizes the risk of data breaches or unauthorized interventions, ensuring that sensitive information remains secure and that decision-making processes are reliable and transparent.

Step 1206 receives the real-time data on property damage, environmental conditions, and infrastructure integrity from the plurality of data sources.

The real-time data related to property damage, environmental conditions, and infrastructure integrity is received from the plurality of sources. This real-time data is dynamically generated by multiple input streams, offering a comprehensive and up-to-the-minute understanding of the disaster's impact. Among the plurality of sources are live video feeds from drones, which provide high-resolution aerial imagery to map out the extent of damage, monitor inaccessible areas, and assess infrastructure collapse. Geospatial data from IoT sensors contribute granular details on environmental factors such as structural vibrations, temperature changes, and air quality, offering precise and localized measurements of disaster effects.

Additionally, the disaster recovery system integrates real-time social media posts and broadcast feeds, capturing a crowd-sourced perspective of the event as it unfolds. Videos and photographic data from these public platforms are ingested and analyzed to enhance situational awareness, enabling the system to identify affected zones, evaluate the severity of conditions, and cross-verify data from other sources. Environmental monitoring devices further enrich the real-time data by supplying continuous updates on conditions such as weather patterns, water levels, and potential secondary risks like landslides or flooding.

To complement these automated inputs, handheld devices used by city officials and first responders play a crucial role in collecting localized data. These handheld devices allow personnel on the ground to record and transmit specific observations, capture geotagged images, and provide manual input on immediate hazards or community needs. Together, these dynamic sources enable the disaster recovery system to create a real-time, multi-dimensional view of the affected area, empowering decision-makers to prioritize resources effectively, streamline recovery efforts, and address immediate safety concerns.

Step 1208 detects, normalizes, and aggregates the received data and subsequently store them within a central data repository.

Once real-time data is received from the plurality of sources, the disaster recovery system initiates a structured process of detection, normalization, and aggregation to ensure the real-time data is accurate, usable, and relevant to disaster recovery efforts. The first step involves detecting incoming data streams and identifying their source types, such as drone feeds, IoT sensor data, social media content, or handheld device inputs. Each data is then subjected to a normalization process, which standardizes the real-time data to ensure consistency regardless of its origin or format. This includes converting diverse data types, such as video files, images, textual information, and geospatial data, into a uniform structure that can be processed by the disaster recovery system.

During normalization, the disaster recovery system also validates the incoming data against predefined standards. This step is critical to ensuring the data's accuracy, completeness, and relevance. For example, it checks for anomalies or errors, such as corrupted video files or incomplete sensor readings, and discards unreliable entries. The validation process also cross-references data with established benchmarks to confirm their relevance to specific disaster recovery parameters, such as infrastructure integrity or environmental conditions.

Once validated and normalized, the real-time data is aggregated into a central data repository, which acts as a secure, centralized hub for all processed information. The central repository organizes the data into meaningful categories, enabling efficient retrieval and analysis. By standardizing and validating the data, the disaster recovery system ensures that decision-makers are working with reliable and actionable information, paving the way for accurate damage assessments, resource allocation, and permit processing. This comprehensive data management framework forms the backbone of the disaster recovery system, enabling coordinated and informed responses to complex crises.

Step 1210 extracting metadata from the ingested data and generating insights on affected areas, including environmental conditions, infrastructure integrity, and demographic impacts.

After data ingestion and normalization, the disaster recovery system advances to metadata extraction, a critical step in transforming raw data into actionable insights. Metadata, descriptive information about the data itself, is derived from the ingested datasets, including details like geospatial coordinates, timestamps, environmental parameters, and object classifications. For instance, drone imagery is tagged with location and altitude data, while IoT sensor readings are linked to specific environmental conditions. This metadata provides a structured framework that helps the system analyze the affected areas in greater depth, offering a detailed understanding of environmental conditions, infrastructure integrity, and demographic impacts. For example, the disaster recovery system can highlight areas experiencing severe air quality degradation or identify buildings with structural vulnerabilities based on geospatial and sensor data.

To further enhance its analytical capabilities, the disaster recovery system employs contextualization by correlating the real-time data with historical datasets. This includes integrating information from past disaster events, urban planning records, and demographic trends. By doing so, the disaster recovery system not only evaluates the current situation but also generates predictive insights for future disaster events. For example, it can identify patterns in flood-prone areas based on historical rainfall and topographical data or predict infrastructure failure points using past records of wear and tear.

These insights are invaluable for both immediate recovery and long-term planning. They enable decision-makers to develop strategies that address the immediate needs of affected populations while also informing policies and designs for resilient infrastructure. For instance, historical correlations might guide the relocation of essential facilities away from high-risk zones or suggest updates to building codes to withstand future disasters. By combining real-time contextual insights with predictive analytics, the disaster recovery system ensures a comprehensive approach to disaster management, balancing recovery efforts with sustainable future planning.

Step 1212 establishes a communicable connection between a decision engine and the central controller.

Establishing a communicable connection between the decision engine and the central controller is a crucial step that ensures seamless data flow and coordinated decision-making within the disaster recovery system. The central controller serves as the primary hub for data ingestion, processing, and storage, while the decision engine acts as the analytical core that interprets this data to deliver actionable insights and automated processes.

The connection between these two components is established using a secure and high-speed communication protocol, which allows the decision engine to access the normalized and contextualized data stored in the central controller in real-time. This enables the decision engine to operate with a comprehensive data that includes information on property damage, environmental conditions, infrastructure integrity, and demographic impacts.

Through this connection, the decision engine can execute advanced machine learning algorithms to categorize the severity of damage, prioritize areas requiring urgent intervention, and automate critical processes such as generating pre-populated permit applications. Furthermore, the connection allows the decision engine to relay its analyses and recommendations back to the central controller, which then disseminates the information to relevant stakeholders, such as municipal authorities, first responders, and urban planners.

By maintaining a constant and reliable connection, the disaster recovery system ensures that the decision engine operates in a synchronized manner with the central controller, enabling rapid, accurate, and data-driven responses to disaster scenarios. This integration also supports feedback loops, where the outcomes of implemented decisions are analyzed and used to refine future operations, fostering continuous improvement in disaster management efforts.

Step 1214 categorizes and prioritizes the severity of the damage using machine learning algorithms.

The disaster recovery system employs advanced machine learning algorithms to analyze the ingested and contextualized data, enabling it to categorize and prioritize the severity of damage in affected areas. These algorithms process diverse data, such as drone imagery, IoT sensor readings, and geospatial information, to assess structural damages, environmental impacts, and demographic effects. By identifying and categorizing damages with precision, the disaster recovery system assigns contextual damage ratings to individual properties or zones. These ratings, which are based on factors such as the extent of structural damage, the criticality of the property's function, and the safety risks involved, provide a clear and quantifiable measure of the severity of each case.

To maintain data integrity throughout this process, the disaster recovery system utilizes blockchain technology. Blockchain ensures that all data, from initial collection to final analysis, is securely recorded with tamper-proof audit trails. Each transaction or modification is cryptographically verified, ensuring transparency and accountability. This is particularly critical in disaster recovery, where trust in data accuracy can directly influence the effectiveness of response efforts and resource allocation.

The disaster recovery system also integrates geospatial data to monitor recovery progress in real-time. By tracking the location and status of ongoing efforts, it ensures that rebuilding aligns with pre-disaster urban planning initiatives and complies with local codes and regulations. This spatial tracking helps prevent unplanned or unsafe redevelopment and promotes the restoration of community structures in a manner that enhances resilience to future disasters.

Using the contextual damage ratings, the disaster recovery system allocates priority for quick recovery to the most critical areas. For instance, properties essential for community well-being, such as hospitals, schools, and shelters, are prioritized based on their damage ratings and significance. This prioritization ensures that limited resources are directed to areas where they will have the greatest immediate impact, accelerating recovery efforts and reducing downtime for essential services. By combining machine learning, blockchain integrity, geospatial tracking, and a prioritization framework, the system delivers a comprehensive, data-driven approach to disaster recovery and rebuilding.

Step 1216 automatically generates pre-populated permit applications that comply with local building codes and environmental regulations.

The disaster recovery system incorporates an automated permit application generation step to streamline and expedite rebuilding efforts in affected areas. Using insights derived from the contextualized data, the disaster recovery system dynamically generates pre-populated permit applications that comply with local building codes and environmental regulations. This automation is powered by an integrated compliance engine that cross-references damage data and rebuilding requirements with relevant legal and environmental standards. By eliminating manual processes, the disaster recovery system reduces administrative bottlenecks and ensures that permit applications are accurate, complete, and ready for immediate submission to municipal authorities. This step not only accelerates the issuance of permits but also ensures adherence to regulatory requirements, facilitating safer and more sustainable rebuilding.

To further enhance the recovery process, the disaster recovery system provides a collaborative interface that fosters seamless cooperation among a diverse range of stakeholders. This interface enables local governments, emergency response agencies, urban planners, environmental experts, and other key entities to work together within a unified platform. By offering real-time access to critical data and analytical tools, the interface ensures that all participants have a shared understanding of priorities and ongoing efforts. Stakeholders can collaboratively review damage assessments, allocate resources, and plan rebuilding strategies, ensuring that recovery efforts are both efficient and well-coordinated.

This collaborative environment also supports smarter resource allocation by enabling stakeholders to collectively analyze contextual insights, such as damage severity and demographic impacts, to prioritize the distribution of funds, materials, and manpower. Furthermore, the disaster recovery system facilitates resilient rebuilding by incorporating expert recommendations on urban planning and infrastructure design, ensuring that redevelopment efforts not only restore but also enhance the affected community's ability to withstand future disasters. By integrating automation with collaboration, the system transforms disaster recovery into an efficient, transparent, and forward-looking process.

Step 1218 automates compliance checks and expedites permit issuance by integrating with government agencies or municipal organizations.

The disaster recovery system utilizes an automation mechanism to automate compliance checks and expedite permit issuance by integrating seamlessly with government agencies and municipal organizations. This integration enables the disaster recovery system to automatically verify that the permit applications generated by the platform comply with local building codes, environmental regulations, and other legal requirements. By linking directly with municipal databases, zoning systems, and regulatory bodies, the disaster recovery system can check each permit submission in real-time against established guidelines. This automation eliminates the need for manual approval processes, significantly reducing the time required to issue permits and ensuring that recovery efforts can move forward swiftly and efficiently.

At the heart of the disaster recovery system is the central controller, which is configured to assess real-time damage and make informed decisions based on the data gathered from the plurality of sources. The central controller evaluates the severity of the damage, the infrastructure needs, and the resources required to address the situation. By prioritizing resource allocation, such as directing personnel, materials, and financial support to the most critical areas, the central controller ensures that recovery efforts are focused where they are needed most. The real-time assessment capability ensures that decisions are made dynamically, responding to changing conditions as the disaster recovery process unfolds.

Incorporating this real-time damage assessment into the permit issuance process, the disaster recovery system can automatically update and prioritize the approval of permits for areas requiring the most urgent repairs or rebuilding. The ability to expedite permit processing ensures that the response to the disaster is timely, with reconstruction happening as quickly as possible. The system's automated approach to compliance and permit issuance, combined with its ability to prioritize recovery efforts, greatly enhances disaster preparedness, response, and recovery, providing a more efficient, coordinated, and proactive recovery process that ultimately reduces the long-term impact of the disaster.

### INDUSTRIAL APPLICATIONS

The damage recovery system has wide-ranging industrial applications in the fields of disaster recovery, emergency management, urban planning, and infrastructure resilience. Its ability to aggregate, analyze, and contextualize data in real-time offers transformative solutions for industries involved in disaster preparedness, response, and rebuilding.

In the construction and urban planning sectors, the damage recovery system facilitates the rapid generation and automated processing of permits, reducing administrative bottlenecks and expediting rebuilding efforts. Integrating with municipal systems, the damage recovery system ensures that new structures comply with local building codes and environmental regulations, supporting sustainable and resilient infrastructure development.

The integration of the damage recovery system with IoT devices, drones, and autonomous vehicles enhances its applicability in industries reliant on geospatial analysis and real-time monitoring. For example, insurance companies can use the damage recovery system for accurate damage assessments, accelerating claim processing and reducing fraudulent activities. Similarly, energy and utility companies can monitor and prioritize the restoration of critical infrastructure such as power lines, water supplies, and communication networks.

Emergency response agencies benefit significantly from the damage recovery system, as it enables seamless coordination among stakeholders. By deploying portable communication infrastructure such as 5G networks, the damage recovery system ensures uninterrupted connectivity in disaster-stricken areas, supporting effective decision-making and efficient resource allocation.

The predictive capabilities of the damage recovery system also find applications in industries focused on risk assessment and disaster mitigation. For instance, urban planners and environmental agencies can use historical and real-time data insights to design cities and infrastructures that are better equipped to withstand natural disasters. The ability of the damage recovery system to simulate future disaster scenarios can inform strategic investments and resource planning, minimizing the impact of potentially catastrophic events.

Moreover, the damage recovery system can be deployed across diverse industries, including logistics and supply chain management, where it can optimize the delivery of relief materials to affected areas. The damage recovery system also aids humanitarian organizations in efficiently allocating resources based on data-driven priorities, ensuring that critical needs are addressed swiftly.

The embodiments herein and the various features and advantageous details are explained concerning the non-limiting embodiments in the following description. Descriptions of well-known components and processing techniques are omitted to not unnecessarily obscure the embodiments herein The examples used herein are intended merely to facilitate an understanding of how the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely to provide a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions, or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A disaster recovery system for recovery and rebuilding processes in affected areas, the system comprising:
a computing unit adapted to integrate with a plurality of data sources;
a central controller comprising a backend server communicably connected to the computing unit, the backend server comprising:
a data receiving component adapted to receive a real-time data on property damage, environmental conditions, and infrastructure integrity from the plurality of data sources;
a data ingestion module adapted to detect, normalize, and aggregate the received data and subsequently store them within a central data repository;
a contextualization module adapted to extract metadata from the ingested data and generate insights on affected areas, including environmental conditions, infrastructure integrity, and demographic impacts;
a decision engine communicably connected to the central controller, wherein the decision engine comprising:
a damage categorization module adapted to categorize and prioritize the severity of the damage using machine learning algorithms;
permit application generator adapted to automate the generation of pre-populated permit applications that comply with local building codes and environmental regulations;
a rapid permit processing module adapted to integrate with government agencies or municipal organizations to automate compliance checks and expedite permit issuance;
characterized in that the central controller is configured to assess real-time damage, prioritize resource allocation, and expedite permit issuance, thereby improving disaster preparedness, response, and recovery.

2. The system of claim 1, wherein the plurality of data sources includes but is not limited to IoT devices, drones, autonomous vehicles, handheld devices, and public data streams.

3. The system of claim 1, wherein the real-time data includes data generated from a plurality of dynamic sources, such as live video feeds from drones, geospatial data from IoT sensors, real-time social media posts, environmental monitoring devices, and broadcast feeds, providing up-to-the-minute information on property damage, environmental conditions, and infrastructure status within the affected area.

4. The system of claim 1, wherein the computing unit further comprises:
a connectivity sub-module adapted to establish portable private 5G networks in disaster-affected areas to ensure uninterrupted data transmission and communication.

5. The system of claim 1, wherein the data receiving component further comprises:
a real-time feed handler sub-module adapted to capture geospatially-tagged high-resolution imagery, video feeds, and sensor data;
a validation sub-module adapted to verify the integrity and accuracy of the received data.

6. The system of claim 1, wherein the central controller further comprises:
a governance sub-module adapted to enforce data governance policies, including compliance with regulatory standards and blockchain-enabled audit trails.

7. The system of claim 1, wherein the contextualization module further comprises:
a metadata extraction sub-module adapted to generate metadata tags for contextual understanding of the data;
a situational analytics sub-module adapted to derive insights about the affected area's environmental conditions, infrastructure integrity, and demographic impacts;
a historical data correlation sub-module adapted to integrate historical datasets with real-time data for predictive analysis.

8. The system of claim 1, wherein the damage categorization module further comprises:
a damage assessment sub-module adapted to apply machine learning algorithms to categorize the severity of damage;
an event prioritization sub-module adapted to rank areas based on urgency and resource requirements;
a resource allocation sub-module adapted to prioritize and recommend the deployment of resources based on damage severity and contextual insights;
a compliance check sub-module adapted to verify permit applications against local building codes and environmental regulations; and
a recommendation sub-module adapted to suggest rebuilding strategies that enhance future disaster resilience.

9. The system of claim 1, wherein the permit application generator further comprises:
a compliance automation sub-module adapted to check local building codes and environmental regulations for pre-populated permit applications;
a template generation sub-module adapted to dynamically generate permit applications in correspondence to specific damage scenarios; and
a document verification sub-module adapted to ensure the accuracy and validity of submitted permit applications.

10. The system of claim 1, wherein the rapid permit processing module further comprises:
an integration sub-module adapted to interface with government systems for real-time permit processing;
a workflow automation sub-module adapted to streamline approval processes by automating administrative tasks;
a tracking sub-module adapted to provide real-time updates on permit application statuses.

11. A method for disaster recovery and rebuilding processes in affected areas, the method comprising:
integrating a computing unit with a plurality of data sources;
establishing a communicable connection between a central controller and the computing unit by:
receiving a real-time data on property damage, environmental conditions, and infrastructure integrity from the plurality of data sources;
detecting, normalizing, and aggregating the received data and subsequently storing them within a central data repository;
extracting metadata from the ingested data and generating insights on affected areas, including environmental conditions, infrastructure integrity, and demographic impacts;
establishing a communicable connection between a decision engine and the central controller by:
categorizing and prioritizing the severity of the damage using machine learning algorithms;
automatically generating pre-populated permit applications that comply with local building codes and environmental regulations;
automating compliance checks and expediting permit issuance by integrating with government agencies or municipal organizations;
characterized in that the central controller is configured to assess real-time damage, prioritize resource allocation, and expedite permit issuance, thereby improving disaster preparedness, response, and recovery.

12. The method of claim 11, wherein the plurality of data sources includes but is not limited to IoT devices, drones, autonomous vehicles, handheld devices, and public data streams.

13. The method of claim 11, wherein the real-time data includes data generated from a plurality of dynamic sources, such as live video feeds from drones, geospatial data from IoT sensors, real-time social media posts, environmental monitoring devices, and broadcast feeds, providing up-to-the-minute information on property damage, environmental conditions, and infrastructure status within the affected area.

14. The method of claim 11, wherein videos and photographic data from social media and public broadcasts are ingested for data assessment.

15. The method of claim 11, wherein the handheld devices used by the city officials and first responders capture real-time localized data.

16. The method of claim 11, wherein the ingesting and normalizing data includes validating the incoming dataset against predefined standards to ensure that the data is accurate, complete, and relevant to the disaster recovery process.

17. The method of claim 11, wherein the contextualizing the dataset further comprises correlating the received data with historical data to generate predictive insights for future disaster events and assist with long-term recovery planning.
